(19) United States
(12) Patent Application Publication
(10) Pub. No.: US 2012/0067946 A1
(43) Pub. Date: Mar. 22, 2012

(54) Telescoping/Retractable Automated Transaction Module

(76) Inventor: Craig J. Johnston, Gainesville, GA (US)

(21) Appl. No.: 12/838,576

(22) Filed: Sep. 22, 2010

(51) Int. Cl. G07F 19/00

(52) U.S. Cl. 235/379

(57) ABSTRACT

The transaction center of the current Automated Teller Machines where a customer completes a variety of financial transactions is a fixed component of a much lager device. This is the same situation at businesses that uses air pressure to transport capsules between customers at drive up stations and the interior of the business to complete various transactions. Since these units in both cases are physically stationary and are normally accessed by person in vehicle and by pedestrians, customers are required to position as best they can their vehicles and themselves as close to these stations as possible to ease their uses of these machines.

By making these transaction centers on the existing ATM's and the Capsule stations on the air transport systems modular with the capability to safely move back and forth to the customer the Transaction Center comes to the customer where their business is completed and then returns to the base unit.

### BACKGROUND

No matter how close you or your vehicle gets to a drive up ATM unit you rarely can get close enough to input your ATM card and reach the selection pad and/or screen without unfastening your seatbelt and/or opening your vehicle door. There is also a strong likelihood that you may damage your tires or wheels or both while trying to get as close as possible to undertake your financial transaction. These constraints make it almost impossible for persons with disabilities to use this convenience and if you drop your card, money or receipt you will most likely need to pull forward in order to exit your vehicle and retrieve your dropped item.

### SUMMARY

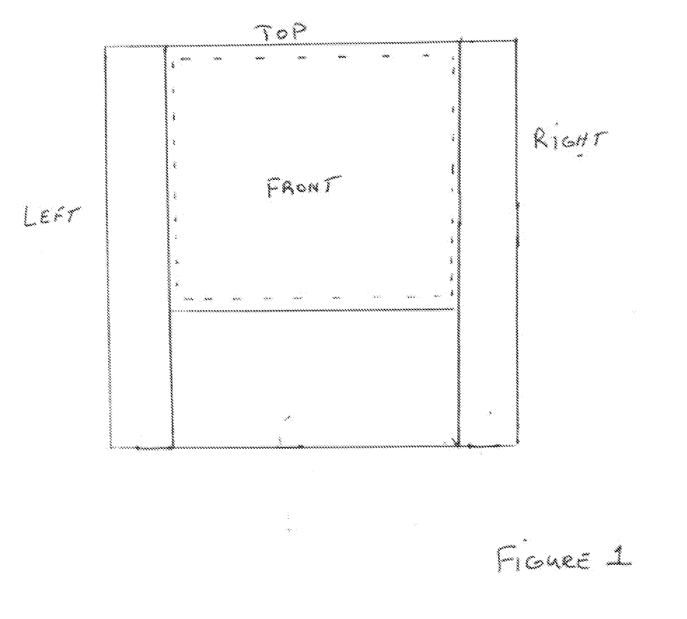

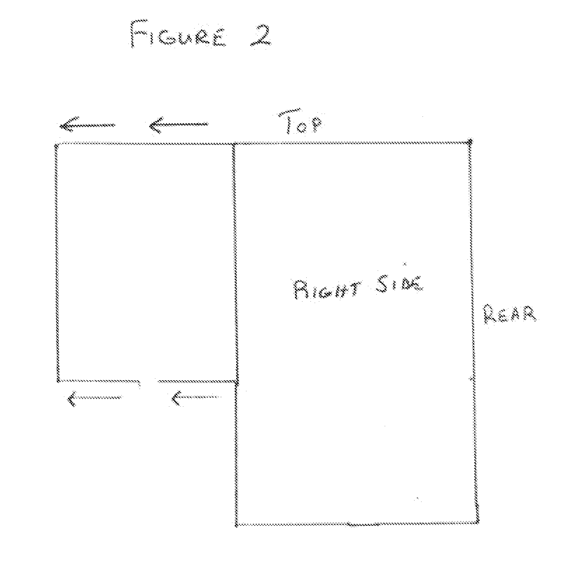

Modify the current design of existing ATM's to include a voice and touch Screen and or keypad activated data entry and transaction retrieval module which is controlled by a combination of sensors, voice commands and depressed keys on a key pad, FIG. 1. When a vehicle or pedestrian enters the predefined sensor range the Transaction Module will automatically deploy the Transaction Module to the pedestrian or the customer in the vehicle. The Transaction Module is where normal ATM Banking functions are undertaken such as; bank card insertion, cash deposits and withdrawals, printing of transaction receipts and various other banking related touch pad and voice command requests. Since there are multiple configuration and services available on ATM's and Air Capsule Remote Delivery stations this patent will cover the ‘Service’ center which would include but will not be limited to the following services; dispersing cash, transaction receipts and other paper forms, acceptance of personal identification cards, checks and deposits, deployment/retraction sensors, entry keypad, touch sensitive viewing screen security camera, etc. FIG. 2.

### DETAILED DESCRIPTION

Upon the base unit sensing the arrival of a pedestrian or vehicle within the predetermined boundaries of the ATM Main base unit, the Transaction Module will deploy until sensors electronically determine that the Transaction Module has reached it's predetermine safe deployment range.

Once deployed, the customer will be prompted by a voice module as well as from visual screen messages to ‘Begin’ the transaction. The Transaction Module will begin the banking process by displaying a menu of choices from which the customer may proceed through their banking transaction.

When the customer has completed the transaction and retrieved their items from the Transaction Module the customer will subsequently return the module to it's housing by depressing the “Return” button on the key pad or by saying ‘Return’.

Obstruction Sensors similar to those used in the automobile industry for sensing the surrounding vehicular perimeter would be engineered into the module to prevent the module from getting to close to the customer vehicle and any pedestrians that might use the ATM. Safety features will include an ‘Obstruction’ function that would reverse the current direction of the module if an obstruction was encountered.

Design modifications to the functions that disperse and/or receive cash, paper receipts and other physical banking items will have to have their respective transport mechanisms extended to accommodate the added distance resulting from the added length of the deployed Transaction Module. The side panels of the extended Transaction Module must be constructed of materials that are strong enough to prevent vandalism and forced access into the deployed Transaction Module and the Transaction Module main housing. Materials that are currently available and that would provide a suitable barrier would be; rolled steel plate or sheet metal, aluminum panels, Kevlar sheeting, and synthetic polymer products.

These side panels should also be constructed in such a way that access into the unit by insects, rodents and weather elements is prevented.

These panels will be interlocking and engineered with a predetermined maximum and minimum engineered deployed ‘stop’, either a mechanical or an electronically activated ‘stop’ device.

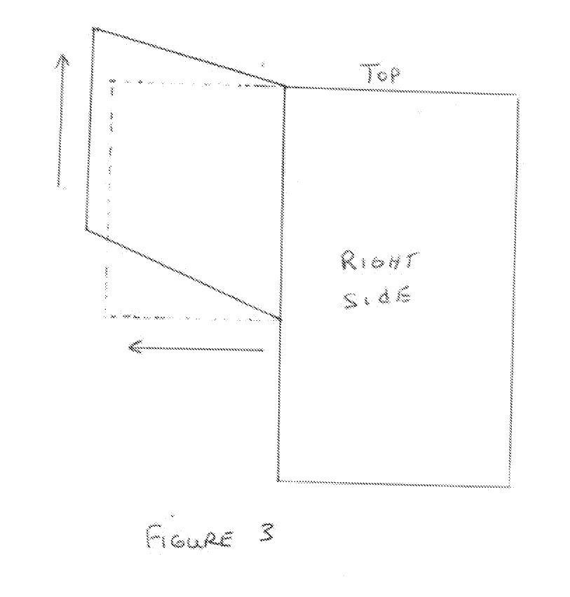

In addition to the forward and reverse movement of the Transaction module, the Transaction Module will be designed to include up and down mobility which can be engaged after the Transaction Module has been fully deployed outward and stopped by the sensor system. This up and down functionality will either be activated by a voice command from the customer by speaking, ‘UP’ or ‘DOWN’, or by pushing the UP or DOWN buttons on the Transaction Module, FIGS. 3 & 4. When the customer transaction is complete the customer will activate the return function and the Transaction Module resets to its closed state and by returning to the main base housing unit.

Deployment of the Transaction Module is very similar to how an old car antenna is extended and then retracted into itself when returned to a closed state. Each section of the antenna has a predetermine length and diameter, including rolled edge at the end of each section which provides a ‘hard stop’ thus allowing the next section to deploy and so forth. The antenna continues to deploy outward until all ‘stops’ are met. Hard ‘stops’ in this design will be controlled by electronic sensors.

During deployment or retraction of the Transaction Module if any obstruction is encountered then the Transaction Module will reverse direction and make 3 attempts to either return to the main base housing unit or towards the customer. If after 3 attempts the obstruction is still being encountered, the unit will be automatically taken offline and place in an out-of-service condition. The main housing unit will be fitted with a wireless modem and/or hard wired telephone line complete with auto-dialer capability.

Predetermined and programmed call numbers will automatically contact local police and bank facility personnel to inform them that a unit is in a failed state which should cause business and police protocols to be activated.

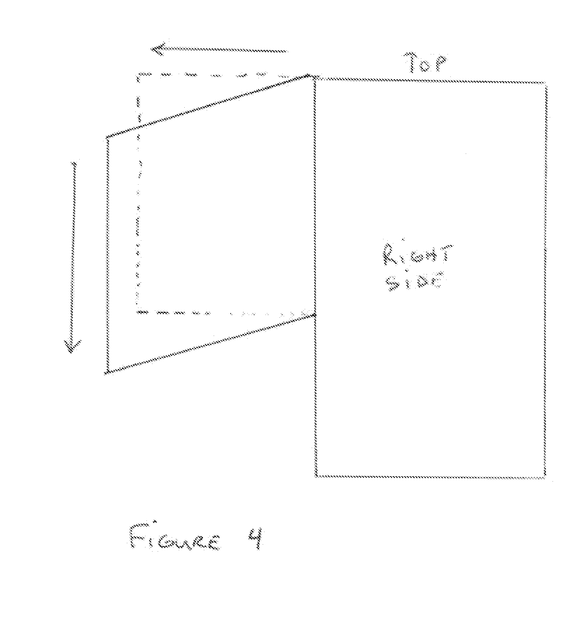

In addition to ATM units, many older financial facilities use a force air tubular mechanism that propels a capsule too and from the interior of the business and back-and-forth between a remote capsule station where a customer places their items in the capsule and returns the capsule to the interior of the business by depressing a send button. These remote stations also have a call button and a microphone with a speaker which allows for two way voice communication. The problem here is exactly the same as the ATM, you can't get close enough to effectively utilize the service. For this application, when the customer pulls up to the Air Tube Capsule Center, the unit housing the capsule will deploy to the vehicle or pedestrian and the customer will easily retrieve the capsule and return it to its return transport tube, FIGS. 5, 6, 7 & 8. The capsule is retrieved and returned as many time as needed and when the transaction is complete, the customer will push the return button and the module will return to a closed state at the original deployment station. The deployed Air Tube Capsule Center will also have upward and downward functionality including the same sensor technology and safety features outlined above for the Transaction Module.

### DRAWINGS

### Brief Description

FIG. 1: Shows a Front Facing View of the Transaction Central Base Unit highlighting a Generic Mobil Transaction Center in a ‘Closed’ state.

FIG. 2: Shows a Right Side Facing View of the Transaction Central Base Unit highlighting the Generic Mobil Transaction Center in a ‘Deployed Outward’ state.

FIG. 3: Shows a Right Side Facing View of the Transaction Central Base Unit highlighting the Generic Mobil Transaction Center in a ‘Deployed Outward and Upward’ state.

FIG. 4: Shows a Right Side Facing View of the Transaction Central Base Unit highlighting the Generic Mobil Transaction Center in a ‘Deployed Outward and ‘Downward’ state.

FIG. 5: Shows a Front Side Facing View of a Generic Air Pressure Transport Portal located at the Transaction Central Base Unit in a ‘Closed’ state.

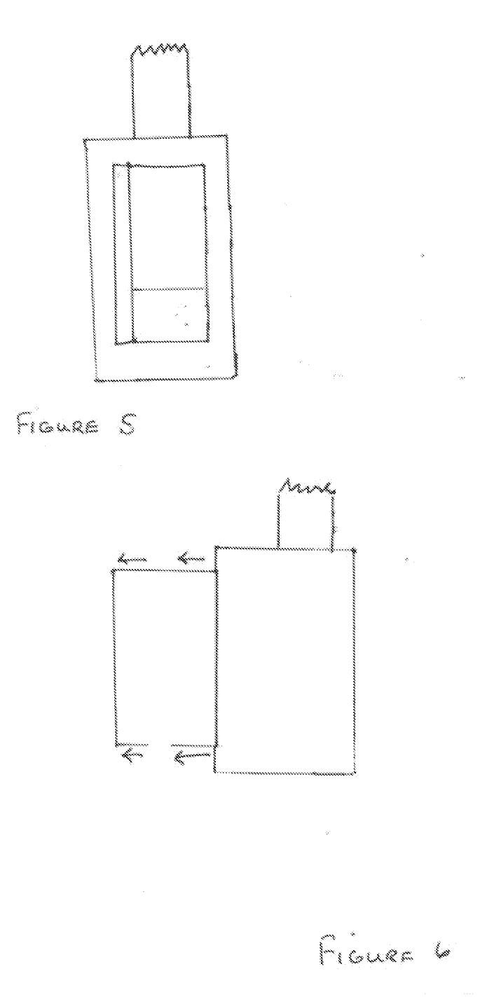

FIG. 6: Shows a Right Side Facing View of a Generic Air Pressure Transport Portal located at the Transaction Central Base Unit in a ‘Deployed Outward’ state.

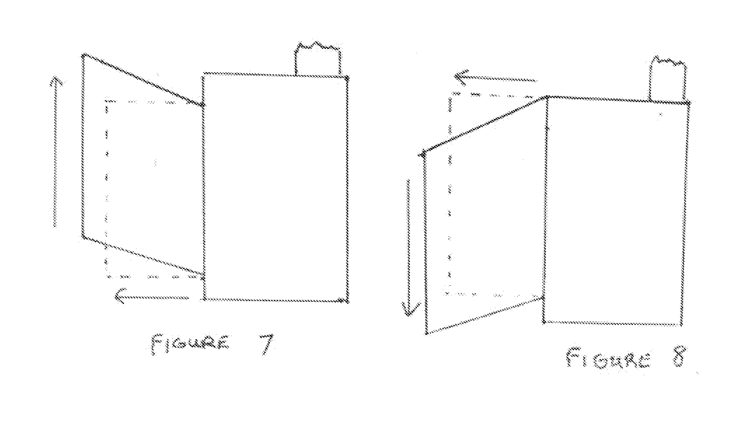

FIG. 7: Shows a Front Side Facing View of a Generic Air Pressure Transport Portal located at the Transaction Central Base Unit in a ‘Deployed Outward and Upward’ state.

FIG. 8: Shows a Front Side Facing View of a Generic Air Pressure Transport Portal located at the Transaction Central Base Unit in a ‘Deployed Outward and Downward’ state.

I. Using a combination of sensors, electrical motorized devices and transport rails the stationary area in an existing Automated Teller Machine where the financial requests, transactions and information is displayed and exchanged will now be modularized and capable to be physically deployed outward and backward to a vehicle or to a pedestrian.

II. Using a combination of sensors, electrical motorized devices and transport rails the stationary area in an existing stationary Air Transport Station which uses a capsule and air pressure to propel a capsule back and forth will be capable of being deployed outward towards the customer and backwards to the Remote Air Transport Station.

III. The Transaction Center will recognized and give verbal commands.

IV. The Transaction Center will recognize physical depressed key commands.

V. The Transaction Center will display transaction information on a screen.

VI. The Transaction Center will receive and disperse cash, paper receipts and paper account information.

VII. Utilization of the machine will benefit Customers.
1. Individuals with disabilities, limited mobility, spinal or injuries either temporarily or permanent will have easier reach and access to the Transaction Module and the Remote Air Transport Station.
2. Convenience to customers will be increased.
